(19) United States
(12) Patent Application Publication
(10) Pub. No.: US 2017/0291730 A1
(43) Pub. Date: Oct. 12, 2017

(54) ROLLER ARRANGEMENT

(71) Applicant: TETRA LAVAL HOLDINGS & FINANCE S.A., Pully (CH)

(72) Inventor: Klas RUDOLFSSON, Lund (SE)

(73) Assignee: TETRA LAVAL HOLDINGS & FINANCE S.A., Pully (CH)

(21) Appl. No.: 15/513,690

(22) PCT Filed: Sep. 22, 2015
(86) PCT No.: PCT/EP2015/071658

§ 371 Date: Mar. 23, 2017

(30) Foreign Application Priority Data
Sep. 23, 2014 (SE) 1451122-4

(51) Int. Cl. B65B 59/04; F16D 1/112; F16D 1/076; B65H 27/00; F16C 13/00

(52) U.S. Cl. CPC B65B 59/04; B65H 27/00; F16C 13/006; F16D 1/076; F16D 1/112; B65H 2301/5126; B65H 2402/52211; B65H 2402/63; B65H 2404/147; B65H 2404/56; B65H 2601/324

(57) ABSTRACT

A roller arrangement for a web processing system, the roller arrangement comprising a roller and at least one rotational shaft having a shaft portion and an attachment portion and wherein the at least one rotational shaft is releasably connectable to the roller.

### TECHNICAL FIELD

Embodiments herein relate to roller arrangements, and in particular roller arrangements for web processing systems.

### BACKGROUND

In processing of a web of material, such as a web of paper-based material, plastic material, etc use is made of rollers. Smooth rollers may be used to guide the web of material along the right path, printing rollers (printing roller arrangements) may be used to apply a print to the web, creasing rollers may be used to apply a relief or crease pattern onto or into the web of material, or cutting rollers which may be used to cut the web of material into subsections.

The main field for the present invention relates to processing of packaging material. This does not imply that the invention as claimed should be limited to this field. Rather it represents the framework within which the present invention was developed and the embodiments used to exemplify the invention will be assembled from this field as well. The skilled person will realize that the application is not limited to this rather narrow field.

A typical example of packaging material is a laminated structure comprising a core layer sandwiched between additional layers or various types. The core layer could be a cellulosic layer, made of cardboard or paperboard, and the additional layers may comprise plastic layers or metallic foils laminated onto the core layer. The plastic layers may be various types of polyethylene or polypropylene and the metallic foils may be e.g. an aluminium foil. The purpose of the core layer is to provide stability and rigidity to a packaging container to be formed from a portion of the web of packaging material, and the purpose of the additional layers may be to provide barriers against moisture, gases, light, radicals, etc to protect the product contained in the formed packaging container. It should be emphasized that the field of packaging material is a field of research in its own right, and the present disclosure does not relate to that field and should not be limited by the very rudimentary examples given above.

One part of the processing of a web of packaging material is the creasing. The creasing refers to a process of providing the packaging material with a pattern of weakening lines or crease lines. When a packaging container is formed from the packaging material the crease lines will be used to define folding lines along which the packaging material will fold.

Creasing is performed with a creasing roller, e.g. a roller having a repetitive pattern of crease lines extending from a smooth surface, such that when the web of packaging material is guided between the creasing roller and a smooth or profiled anvil roller the pattern (or the negative thereof) will be transferred to the packaging material.

Such a creasing roller may have to be replaced at times, either due to wear or due to that the packaging material (or a new packaging material) should be processed for a new type of packaging container, necessitating a new crease pattern.

In a real situation an entire creasing unit comprising creasing rollers is replaced, i.e. an entire segment of a web processing line is replaced.

The description so far exemplifies a situation where one or more rollers are to be replaced, and it is readily realized that the replacement should preferable be performed at some speed and with a high accuracy, which is the point to remember. The actual situation may be completely different, it may be a printing roller that needs to be replaced or another roller completely. A related example is the rollers of a lamination system, i.e. a web processing system where the packaging material is formed through several lamination steps.

The present disclosure will thus provide a technical solution enabling a fast and accurate replacement of a roller.

### SUMMARY

To this end the present disclosure relates to a roller arrangement for a web processing system, said roller arrangement comprising a roller and at least one rotational shaft having a shaft portion and an attachment portion and wherein said at least one rotational shaft is releasably connectable to the roller. With the suggested solution a roller may be, compared to existing solutions, easily replaced or removed for any conceivable purpose.

The roller may be any sort of roller used in a web processing system, yet with a focus on rollers experiencing a need for a more frequent change. Examples may include, but are not limited to, a printer roller, a creasing roller, a guide roller, etc.

In one or more embodiments the attachment portion may comprise first connection means matingly connectable with second connection means arranged on the roller, such as to enable a reliable and repeatable disengagement and coupling.

A releasable connection is a wide definition, and in one or more embodiments a coupling between the first and second connection means is controllable by means of pneumatics, hydraulics, mechanics, electronics, magnetism or any combination thereof. In one or several related embodiment a quick-coupling used in machining arrangements may be used.

The first and second connection means comprises between 1 and 5 connection points each, such as 1, 2, 3, 4, or 5 connection points, in one or more embodiments.

In one or several embodiments one rotational shaft has a portion with a uniform cross section such as to enable it to be slidably suspended in a sleeve. A slidable suspension will enable a movement in an axial direction of one or each of the shaft portions as well as the roller.

The roller arrangement may in one or more embodiments comprise a retraction mechanism arranged to retract said one rotational shaft in a step of disengaging the attachment portion from the roller. The retraction mechanism may comprise a servomotor having a shaft connectable to the shaft of said one rotation shaft, yet the operation may also be more or less manual. In one or more embodiment the entire suspension may be movable in an axial direction, or it may be possible to tilt the suspension or a larger arrangement comprising the suspension so as to enable a separation of components included in the roller arrangement, e.g. disengaging the first or second rotational shaft from the roller.

It one or many embodiments it may be preferred that the shaft portions on either side of the roller are releasably attached or releasably connectable, such that the arrangement comprises a first rotational shaft releasably connectable to the roller at one end thereof and a second rotational shaft arranged on the second end thereof. This will simplify the process of removing/replacing a roller from the roller arrangement even further.

In such an embodiment it may be preferred, though not necessary, that a disengagement of the first rotational shaft from the roller and the second rotational shaft from the roller is selectively and individually controllable. In this way any release sequence desired may be effected. As an example, a method for replacing a roller of a roller arrangement in a web processing system, the roller arrangement comprising the roller and at least one rotational shaft portion releasably connected to the roller, may comprise disconnecting the roller from the at least one rotational shaft, removing the roller from its position in the web processing system, and whilst removing the roller from its position disconnecting or releasing the roller from the second shaft portion if any such second shaft portion is releasably arranged.

The method may in one or more embodiments further comprise aligning a new roller with the at least one rotational shaft in the web processing system, connecting the rotational shaft to the roller by means of a releasable connection.

### BRIEF DESCRIPTION OF THE DRAWINGS

FIG. 1 is a schematic perspective view of a schematic web processing system.

FIG. 2 is a simplistic perspective view of a packaging container formed from packaging material.

FIG. 3 is a cross sectional view of a roller arrangement in a connected or coupled state.

FIG. 4 is a cross sectional view of the roller arrangement of FIG. 3, yet in a released state.

FIG. 5 is a partial view of a roller with a focus on an attachment portion thereof.

FIG. 6 is a view of a shaft portion with a focus on an attachment portion thereof.

FIG. 7 is schematic cross section of a suspension of a shaft portion.

### DETAILED DESCRIPTION

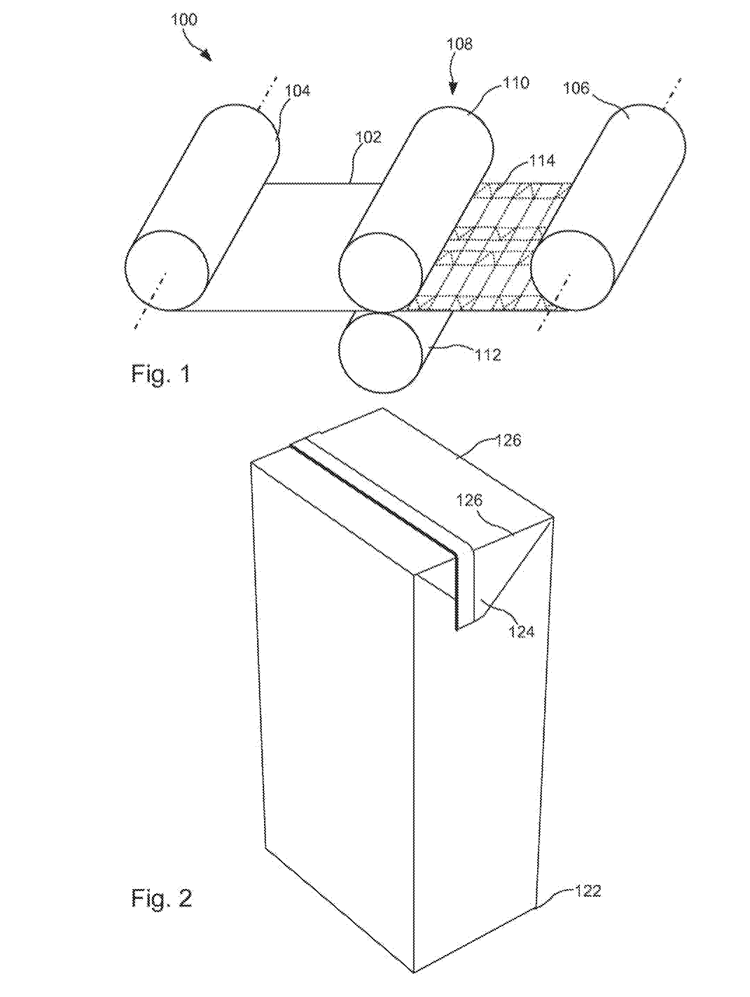

In Fig.1 a simplified web processing system 100 is shown. A web 102 of packaging material is transferred from a first roller 104 to a second roller 106. Between the first and second roll a creasing unit 108 is arranged. The creasing unit comprises an upper roller 110 having a creasing pattern and a lower roller 112 having a resilient surface or a creasing pattern complementary to the creasing pattern of the upper roll.

The web of packaging material is clamped between the creasing rollers and thereby a creasing pattern is formed onto the web of packaging material, as indicated by the dotted lines 114.

Apart from providing lines of weakness the creasing pattern 114 may have a decorative effect, and effect of increasing grippability for a user gripping a packaging container formed from the packaging material, just to mention a few non-exhaustive examples. Following the creasing process the creased packaging material is subject to further processing before being used to form packaging containers.

FIG. 2 illustrates a packaging container which may be formed from the packaging material processed in FIG. 1 (the creasing pattern would have to be altered). The packaging container has a parallelepiped shape, and each fold used to form corners 122, fins 124 etc. be enabled by one or more creasing lines 126 being part of the creasing pattern 114, or formed by a further creasing process. Again, neither the creasing process nor the formation of packaging containers represent the core of the present disclosure, yet the schematic creasing unit of FIG. 1 may still be used to start a description of an example of the need of the invention according to one or more embodiments.

A web processing line as the one exemplified in relation to FIG. 1 is in a practical situation a highly complex processing plant which is used for processing of various types of packaging materials which in turn is processed to be used for different types of packaging containers. A processing line is therefore and arrangement having some degree of flexibility. One example may be that the creasing rollers 110, 112 may be replaced if the packaging material should be used for a packaging container having a different format, apart from a normal replacement due to wear. Other rollers may need to be replaced, both as an effect of wear, but more often to accommodate a new type of packaging material used for a new type of packaging container (new in relation to what is currently running in the processing line). A replacement would also necessitate further adjustments in terms of web tension etc. Such replacements may be made several times during a working shift. The processing line, be it a creasing line or a lamination line, processes the web of packaging material at a high speed with extreme precision. For example, printing, creasing and cutting are performed in different stations, yet the operations have to be perfectly aligned. When creasing rollers are to be replaced it is therefore quite a complex operation, where commonly an entire creasing unit comprising creasing rollers, guide rollers is replaced at the same time, i.e. the entire unit is disassembled from the processing line and a new creasing unit is put in its place. Apart from being a time consuming and cumbersome operation the cost of having multiple creasing units available is significant.

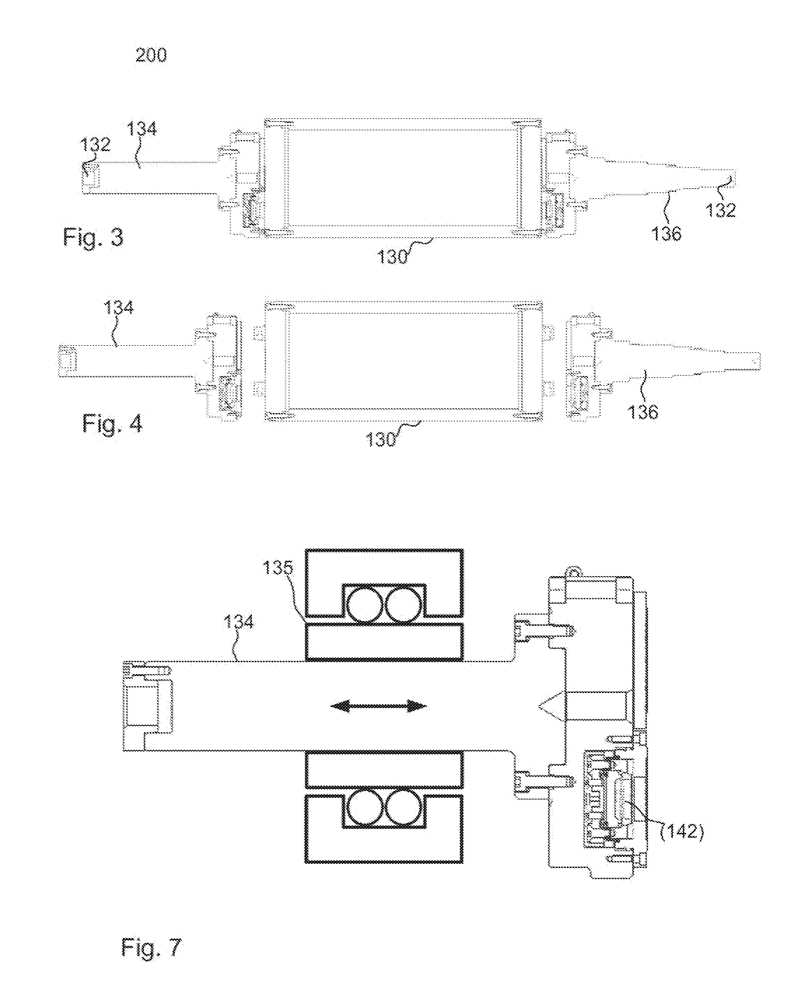

Turning now to the present invention, FIG. 3 illustrates a roller arrangement corresponding to, for example, one of the rollers 110 or 112 (or both) of FIG. 1. The roller arrangement comprises a roller 130 and a rotational shaft 132. The rotational shaft 132 is what will suspend the roller 130 when arranged in the web processing line. The roller 130 may when used be passive, such that both ends of the rotational shaft 132 are suspended by a suitable bearing (not shown), while the drive of the roller 130 is provided by the web passing over it. This may be the typical setup for a guide roller. In situations when the roller performs an actual operation in relation to the web, such as a creasing operation or a cutting operation, one or both of the ends of the rotational shaft 132 may be connected to a drive system.

In the present disclosure it is suggested that the rotation shaft comprises one shaft portion, 134 and 136 respectively, on each side of the roller shafts, releasably attached to the roller 130. In one or more embodiments only one of the shaft portions may be releasably attached to the roller, yet in the preferred embodiments both rotational shafts are releasably attached to the roller, on either side thereof.

The effect of this feature is that a roller may be replaced without interfering with the suspension in such a way that the tolerances are maintained. Furthermore the feature enables a reduced downtime in connection with change or replacement of a roller. Also the need of having a separate creasing unit for each setup, such as each type of packaging material, each type of packaging container, etc.

In FIG. 4 it is shown how the both shaft portions have been released from the roller, thereby enabling for the roller to be replaced or maintained in any other way. The coupling between one or both of the shaft portions (depending on the embodiment) should be of a releasable nature. Though it is not an absolute necessity it is preferred that the coupling is of a quick-release nature that provides a straightforward and reliable coupling with high precision and repetitive behavior, such that any fine tuning associated with a replacement of a roller is reduced to a minimum.

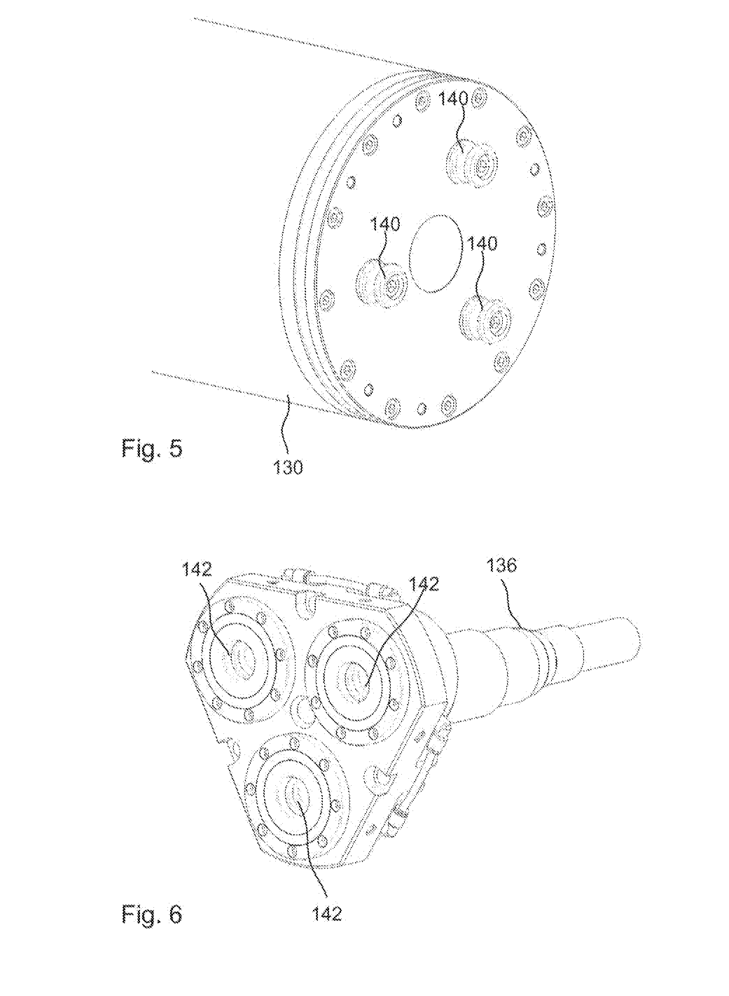

FIGS. 5 and 6 illustrate more detailed perspective views of coupling portions or attachment portions of the roller (FIG. 5) and the shaft portion (FIG. 6) respectively. The roller attachment portion comprises a number of coupling pins 140, in the specific embodiment there are three coupling pins. The shaft attachment portion comprises coupling inserts 142 in an arrangement being arranged matingly with the coupling pins 140 of the roller attachment portion. The coupling inserts may be controllable chucks (pneumatically controlled, hydraulically controlled, electrically controlled, or controlled in another way) such that the coupling and release of the roller may be remotely and directly controlled. To fulfill requirements of the coupling chucks of the type used in various machining systems may be used. Such chucks may provide the repeatable precision and may be capable of withstanding the high loads and forces that may be present in e.g. creasing systems.

FIG. 7 shows a further feature that may be used for one or both of the shafts 134, 136, namely a slidable arrangement of one or both of the shafts enabling a retraction (movement in an axial direction) of the shaft in relation to the roller 130. In the specific example one second shaft portion (136—not shown in FIG. 7) may be fixedly arranged in a bearing, such that it may rotate but not necessarily moved in an axial direction, while the first shaft portion 134 may indeed be slidably arranged. A sequence of removing the roller may in the present embodiment comprise the steps of actuating a release of the coupling between the first shaft portion 134 and the roller 130; sliding the first shaft portion 134 away from the roller such as to effect a release; actuating a release of the coupling between the second shaft portion 136 and the roller 130; sliding the roller 130 away from the second shaft portion 136 such as to complete the release. For the roller to be slidable the rotational shaft should preferably have a portion or segment extending in an axial direction having a uniform cross section.

In other embodiments the order of the steps disclosed may be shifted. For example the second shaft portion may be release first, in which case the first shaft portion may be used to pull the roller away from the second shaft portion. In still other embodiments the first and the second shaft portion may be released from the roller at the same time, or at least before any further steps are initiated.

1.-12. (canceled)

13. A roller arrangement for a web processing system, said roller arrangement comprising a roller and at least one rotational shaft having a shaft portion and an attachment portion and wherein said at least one rotational shaft is releasably connectable to the roller, wherein the attachment portion comprises first connection means matingly connectable with second connection means arranged on the roller and wherein a coupling between the first and second connection means is controllable by means of pneumatics, hydraulics, mechanics, electronics, magnetism or any combination thereof.

14. The roller arrangement of claim 13, wherein the roller is a printer roller, a creasing roller, or any other roller used in a web processing system.

15. The roller arrangement of claim 13, wherein the first and second connection means comprises between 1 and 5 connection points.

16. The roller arrangement of claim 13, wherein one rotational shaft has a portion with a uniform cross section such as to enable it to be slidably suspended in a sleeve.

17. The roller arrangement of claim 16, further comprising a retraction mechanism arranged to retract said one rotational shaft in a step of disengaging the attachment portion from the roller.

18. The roller arrangement of claim 13, comprising a first rotational shaft releasably connectable to the roller at one end thereof and a second rotational shaft arranged on the second end thereof.

19. The roller arrangement of claim 18, wherein a disengagement of the first rotational shaft from the roller and the second rotational shaft from the roller is selectively and individually controllable.

20. The roller arrangement of claim 13, wherein a suspension for suspending the rotational shaft is directly or indirectly tiltable for the purpose of disengaging the rotational shaft from the roller.

21. Method for replacing a roller of a roller arrangement in a web processing system, the roller arrangement comprising the roller and at least one rotational shaft releasably connected to the roller, comprising disconnecting the roller from the at least one rotational shaft, removing the roller from its position in the web processing system further comprising aligning a new roller with the at least one rotational shaft in the web processing system and connecting the rotational shaft to the roller by a releasable connection.
